(19) United States
(12) Patent Application Publication
(10) Pub. No.: US 2009/0186499 A1
(43) Pub. Date: Jul. 23, 2009

(54) Electrical connector having suction recess

(75) Inventors: Zhong-Jun Ma, ShenZhen (CN); Nan Hu, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/321,265

(22) Filed: Jan. 16, 2009

(30) Foreign Application Priority Data
Jan. 17, 2008 (CN) 200820030697.7

(51) Int. Cl. H01R 12/00

(52) U.S. Cl. 439/79

(57) ABSTRACT

An electrical connector adapted for receiving an electrical card therein, comprising an insulative housing having upper and lower surfaces, with a plurality of passageways extending therebetween; a plurality of contacts assembled to the passageways, each including a contact engaging portion extending above the upper surface; and a metal shell attached to the housing and defining a receiving space with the upper surface of the housing, the metal shell having a suction recess defined thereon. The suction recess is located at the top surface of the metal shell, and a geometric center of the suction recess of the metal shell about Z-axis coincides with a center of gravity of the electrical connector about Z-axis.

### BACKGROUND OF THE INVENTION

1. Field of the Invention

The present invention generally relates to an electrical connector, and more particularly to an electrical connector having a suction recess formed in the shell.

2. Description of Related Art

Taiwan. Pat. NO TWM 291105 disclosed an electrical connector for receiving an electrical card therein. The electrical connector comprises an insulative housing, a metal shell and several terminals. The metal shell overcasts the top of the insulative housing, and a card receiving space formed between the insulative housing and the metal shell. The metal shell defines a through hole respectively in two sides thereof, and the insulative housing defines a button corresponding to aforementioned through hole. While the electrical card inserting into the connector, the metal shell and the insulative housing is kept steadily by the cooperation of the through hole and the button.

When the connector assembled to the printed circuit board, the electrical connector require manipulation by means of a vacuum suction nozzle for proper positioning onto the printed circuit board. The vacuum suction nozzle engages the top surface of the shell and thereby picks up the electrical connector.

however, the shell doesn't have a regular position for engaging by the vacuum suction nozzle, and the connector is liable to tilt with respect to the center of gravity of the connector. This can result in a gap being opened between the vacuum suction nozzle and the shell of the connector, and leakage of air into the vacuum suction nozzle. If the leakage is substantial, the connector falls off from the vacuum suction nozzle.

Hence, an improved electrical connector with a metal shell is highly desired to overcome the disadvantages of the related art.

### SUMMARY OF THE INVENTION

Accordingly, an object of the present invention is to provide a suction recess for facilitating manipulation of an electrical connector onto an electronic apparatus, whereby the suction recess can reliably engage with a vacuum suction nozzle.

In order to achieve the object set forth, an electrical connector adapted for receiving an electrical card therein, comprising an insulative housing having upper and lower surfaces, with a plurality of passageways extending therebetween; a plurality of contacts assembled to the passageways, each including a contact engaging portion extending above the upper surface; and a metal shell attached to the housing and defining a receiving space with the upper surface of the housing, the metal shell having a suction recess defined thereon. The suction recess is located at the top surface of the metal shell, and a geometric center of the suction recess of the metal shell about Z-axis coincides with a center of gravity of the electrical connector about Z-axis.

When the vacuum suction nozzle sucks the connector, the suction recess ensures that the vacuum suction nozzle can reliably engage with the connector.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of the electrical connector in accordance with the first embodiment of the present invention; and

FIG. 2 is an exploded, perspective view of the electrical connector.

### DETAILED DESCRIPTION OF THE INVENTION

Reference will now be made in detail to the preferred embodiment of the present invention.

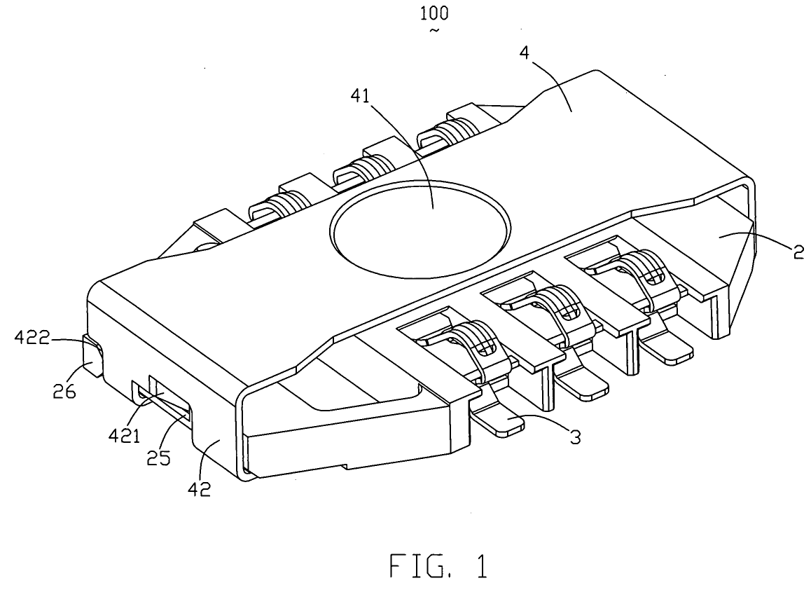

Referring to FIG. 1, an electrical connector 100 in accordance with the present invention includes an insulative housing 2, a plurality of contacts 3 respectively arranged in two rows along a vertical direction and received in the insulative housing 2, and a metal shell 4 assembled to the insulative housing 2.

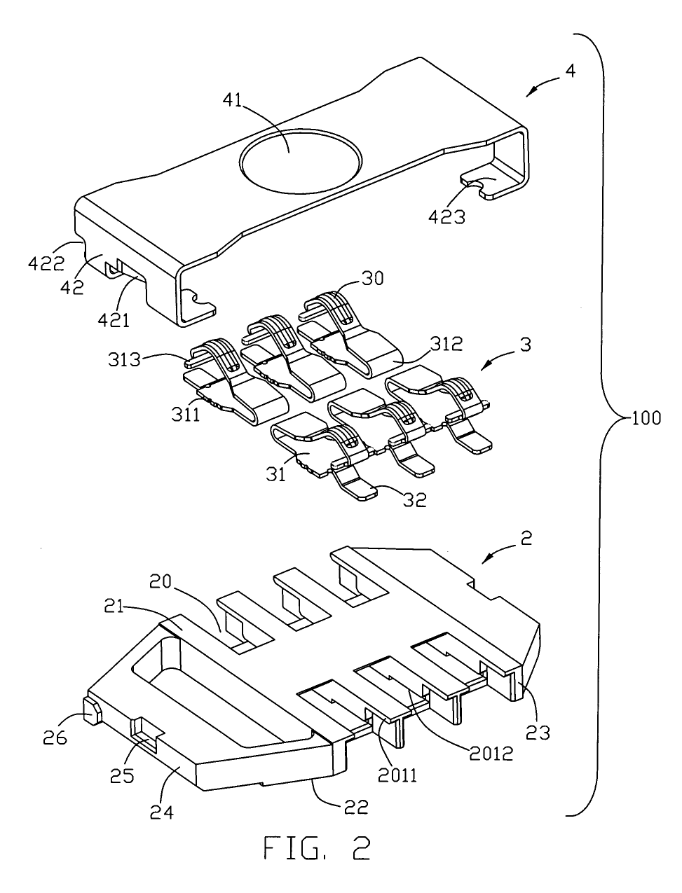

Referring to FIG. 2, The housing 2 has a upper surface 21 for proximity to a SIM card (not shown), a lower surface 22 for proximity to a printed circuit board (not shown), two opposite longitudinal sides 23 and two opposite lateral sides 24 between the upper and lower surfaces 21, 22. Two sets of three contact passageways 20 are defined in the upper surface 21 and extend from the two longitudinal sides 23 toward a middle portion of the housing 2, respectively. Each contact passageway 20 defines a depression portion 201 which forms stops 2011 thereabove and a channel portion 2012 therein. The housing 2 further includes a pair of grooves 25 formed at the middle of the lateral sides 24 respectively, and a pair of blocks 26 formed at the end of the lateral sides 24 respectively.

Two sets of three contacts 3 are mounted into the corresponding contact passageways 20. Each contact 3 has a fitting portion 31 with barbs 311 on two longitudinal sides thereof. A soldering portion 32 extends below and rearward from the fitting portion 31 for mounted on a PCB (not show). An arced bridging section 312 extends in front of the corresponding fitting portion 31 to connect with a corresponding contact portion 30 for engaging with the SIM card (not shown). The contact portion 30 is located above the fitting portion 31 and is terminated at an enlarged free end 313 thereof.

A metal shell 4 covers on the top of the insulative housing 2, with a receiving space (not label) for receiving the electrical card therein, and formed between the upper surface 21 of the insulative housing 2 and the metal shell 4. The metal shell 4 have a suction recess 41 with a circular form and located at the top surface thereof, and a geometric center of the suction recess 41 of the metal shell 4 about Z-axis coincides with a center of gravity of the electrical connector 100 about Z-axis. The metal shell 4 further includes a pair of sidepieces 42 respectively defined at the lateral sides thereof. The sidepiece 42 has a locking portion 421 corresponding to the groove 25, a notching 422 corresponding to the block 26, and a hook 423 extending on a lower surface 22 of the housing 2.

To assemble the connector 100, first, the two sets of contacts 3 are successively mounted into the contact passageways 20 by extending the fitting portions 31 into the corresponding channels 2012 to reach a position in which the fitting portions 31 are located in the corresponding contact passageways 20 and compressed by the housing 2; second, the metal shell 4 is mounted to housing 2 from the opposite direction of the block 26, the locking portion 421 locks the groove 25 steadily, and the notching 422 locks the block 26 tightly in horizontal direction. The hook 423 is clung to the lower surface 22 of the insulative housing 2. The connector 100 is finished thereby.

In this present invention, the center of gravity of the connector 100 must be identified and projected onto the shell 4, then a suction recess 41 defined at the top surface of the shell 4. In addition, the suction recess 41 just has a suitable space for admitting a vacuum suction nozzle (not show) only. When the vacuum suction nozzle sucks the connector 100, the suction recess 41 ensures that the vacuum suction nozzle can reliably engage with the connector 100.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

What is claimed is:

1. An electrical connector adapted for receiving an electrical card therein, comprising:
an insulative housing having upper and lower surfaces, with a plurality of passageways extending therebetween;
a plurality of contacts assembled to the passageways, each including a contact engaging portion extending above the upper surface; and
a metal shell attached to the housing and defining a receiving space with the upper surface of the housing, the metal shell having a suction recess defined thereon.

2. The electrical connector as claimed in claim 1, wherein suction recess is located at the top surface of the metal shell, and a geometric center of the suction recess of the metal shell about Z-axis coincides with a center of gravity of the electrical connector about Z-axis.

3. The electrical connector as claimed in claim 2, wherein the suction recess has a circular form.

4. The electrical connector as claimed in claim 3, wherein the electrical connector requires manipulation by means of a vacuum suction nozzle for proper positioning onto the printed circuit board, and the suction recess just has a suitable space for admitting a vacuum suction nozzle only.

5. The electrical connector as claimed in claim 4, wherein the metal shell further includes a pair of sidepieces respectively defined at the transverse ends thereof.

6. The electrical connector as claimed in claim 5, wherein a locking portion is defined at the middle of the sidepiece, and the housing defines a groove corresponding to the locking portion.

7. The electrical connector as claimed in claim 6, wherein the housing further has a block formed at the lengthwise end thereof, and the sidepiece defines a notching corresponding to the block.

8. The electrical connector as claimed in claim 7, wherein the sidepiece has a hook extending on a lower surface of the housing.

9. An electrical connector comprising:
an insulative housing defining opposite upper and bottom surfaces;
a plurality of contacts disposed in the housing with contacting sections extending upwardly beyond the upper surface;
a shell with a suction plane thereon, attached upon the housing and defining a top wall with two side walls downwardly extending from two opposite side edges of the top wall across the housing in a transverse direction, each of said side walls defining locking portion received in a groove in a corresponding side face of the housing; wherein
each of said side walls is further equipped with a hook portion at a bottom portion to be received under the bottom surface; wherein
via cooperation of the locking portion and the groove, and that of the hook portion and the bottom surface, the shell is only allowed to be assembled to the housing horizontally.

10. The electrical connector as claimed in claim 9, wherein the housing defines a block and the shell defines a notch receiving said block so as to prevent downward movement of the shell relative to the housing.
